(19) United States
(12) Patent Application Publication
(10) Pub. No.: US 2013/0044029 A1
(43) Pub. Date: Feb. 21, 2013

(54) METHOD, APPARATUS, AND SYSTEM FOR CONTROLLING MULTI-ANTENNA SIGNAL TRANSMISSION

(71) Applicants: Xuezhi YANG, Beijing (CN); Wei JIANG, Shenzhen (CN)

(72) Inventors: Xuezhi YANG, Beijing (CN); Wei JIANG, Shenzhen (CN)

(21) Appl. No.: 13/654,743

(22) Filed: Oct. 18, 2012

Related U.S. Application Data
(63) Continuation of application No. PCT/CN2011/074395, filed on May 20, 2011.

(30) Foreign Application Priority Data
Oct. 18, 2010 (CN) 201010510079.4

(51) Int. Cl. H01Q 3/26

(52) U.S. Cl. 342/373

(57) ABSTRACT

A method for controlling multi-antenna signal transmission includes: at a first transmission time, selecting a weight vector of a signal beam whose fluctuation in angle dimension is smaller than a preset value as a first basic weight vector; weighting a signal of each antenna array element in a multi-antenna system by using the first basic weight vector, to obtain a first weighted signal on each antenna array element; and delaying the first weighted signal on each antenna array element for a corresponding set time period, so that the multi-antenna system has different transmission modes at different frequencies, and transmitting each delayed first weighted signal through its corresponding antenna array element.

### CROSS-REFERENCE TO RELATED APPLICATIONS

This application is a continuation of International Application No. PCT/CN2011/074395, filed on May 20, 2011, which claims priority to Chinese Patent Application No. 201010510079.4, filed on Oct. 18, 2010, both of which are hereby incorporated by reference in their entireties.

### FIELD OF THE INVENTION

The present invention relates to multi-antenna technologies, and in particular, to a method, an apparatus, and a system for controlling multi-antenna signal transmission.

### BACKGROUND OF THE INVENTION

A radio communications system involves broadcast, multicast, and unicast signals. Unicast refers to transmitting a specific signal to a specific user, whereas multicast and broadcast refer to transmitting a specific signal to multiple or all users. For example, system information on a broadcast channel (Broadcast Channel, BCH) in the mobile communications system, and multimedia broadcast and multicast service (Multimedia Broadcasting and Multicasting Service, MBMS) data on a multicast channel (Multicast Channel, MCH) belong to broadcast and multicast signals. Broadcast signals need to be transmitted to all directions of a cell or sector with the same signal quality.

Regardless of an omni-directional antenna or a directional antenna, signals transmitted by a single antenna are capable of covering a whole cell or sector, and a single-antenna base station is capable of implementing broadcast transmission easily. In an existing base station configured with multiple antennas, generally one antenna array element is selected from an omni-directional or directional antenna array or a new antenna array element is added to transmit broadcast signals. In this way, to achieve coverage of a cell or sector that is the same as the coverage implemented through multiple antennas, a high-power amplifier needs to be configured for the antenna array element.

However, the power amplifier is costly, and consumes much power. As a result, the existing solution is disadvantageous in high cost and high power consumption, and is not suitable for commercial use in practice. Consequently, complete coverage of a cell or sector fails to be effectively implemented.

### SUMMARY OF THE INVENTION

Embodiments of the present invention provide a method, device, and system for controlling multi-antenna signal transmission for effectively implementing complete coverage of a cell or sector.

An embodiment of the present invention provides a method for controlling multi-antenna signal transmission. The method includes: at first transmission time, selecting a weight vector of a signal beam whose fluctuation in angle dimension is smaller than as preset value as a first basic weight vector; weighting a signal of each antenna array element in multiple antennas by using the first basic weigh vector to obtain a first weighted signal on each antenna array element; and delaying the first weighted signal on each antenna array element for a corresponding set time period and transmitting the signal.

An embodiment of the present invention provides an apparatus for controlling multi-antenna signal transmission. The apparatus includes: a selecting unit, configured to, at first transmission time, select a weight vector of a signal beam whose fluctuation in angle dimension is smaller than a preset value as a first basic weight vector; a weighting unit, configured to weight a signal of each antenna array element in multiple antennas by using the first basic weight vector to obtain a first weighted signal on each antenna array element; and a transmitting unit, configured to delay the first weighted signal on each antenna array element for a corresponding set time period and transmit the signal.

An embodiment of the present invention further provides a system for controlling multi-antenna signal transmission. The system includes: an apparatus for controlling multi-antenna signal transmission and multiple antenna array elements. The apparatus for controlling multi-antenna signal transmission is configured to, at a first transmission time, select a weight vector of a signal beam whose fluctuation in angle dimension is smaller than a preset value as a first basic weight vector; weight a signal of each antenna array element in a multi-antenna system by using the first basic weight vector to obtain a first weighted signal on each antenna array element; and delay the first weighted signal on each antenna array element for a corresponding set time period and transmit the signal.

According to the embodiments of the present invention, transmit signals are weighted by using the basic weight vector and are delayed. A frequency diversity effect is achieved through a simple delay operation, and an obtained beam mode is a binary function of a direction angle and a signal frequency. When the direction angle is fixed, a signal beam mode still varies with the signal frequency. The frequency diversity effect is achieved through the simple delay operation, so that the average beam of beams at all frequencies is unrelated to the direction angle. In this way, the average transmit power of multi-antenna signals is equal in all directions, effectively implementing complete coverage of a cell or sector.

### BRIEF DESCRIPTION OF THE DRAWINGS

FIG. 1 is a flowchart of a method for controlling multi-antenna signal transmission according to a first embodiment of the present invention;

FIG. 2 is a schematic structural diagram of a multi-antenna system according to an embodiment of the present invention;

FIG. 3 is a flowchart of a method for controlling multi-antenna signal transmission according to a second embodiment of the present invention;

FIG. 4 is a beam direction diagram of the method for controlling multi-antenna signal transmission according to the second embodiment of the present invention;

FIG. 5 is a direction diagram of the average beam of all beams at different signal frequencies according to an embodiment of the present invention;

FIG. 6A is a schematic structural diagram of a frame in a TD-SCDMA system according to an embodiment of the present invention;

FIG. 6B is a schematic structural diagram of a timeslot in a TD-SCDMA system according to an embodiment of the present invention;

FIG. 7 is a curve diagram of emulation verification of a method for controlling multi-antenna signal transmission according to an embodiment of the present invention;

FIG. 8 is a schematic structural diagram of an apparatus for controlling multi-antenna signal transmission according to an embodiment of the present invention; and

FIG. 9 is a schematic structural diagram of a system for controlling multi-antenna signal transmission according to an embodiment of the present invention.

### DETAILED DESCRIPTION OF THE EMBODIMENTS

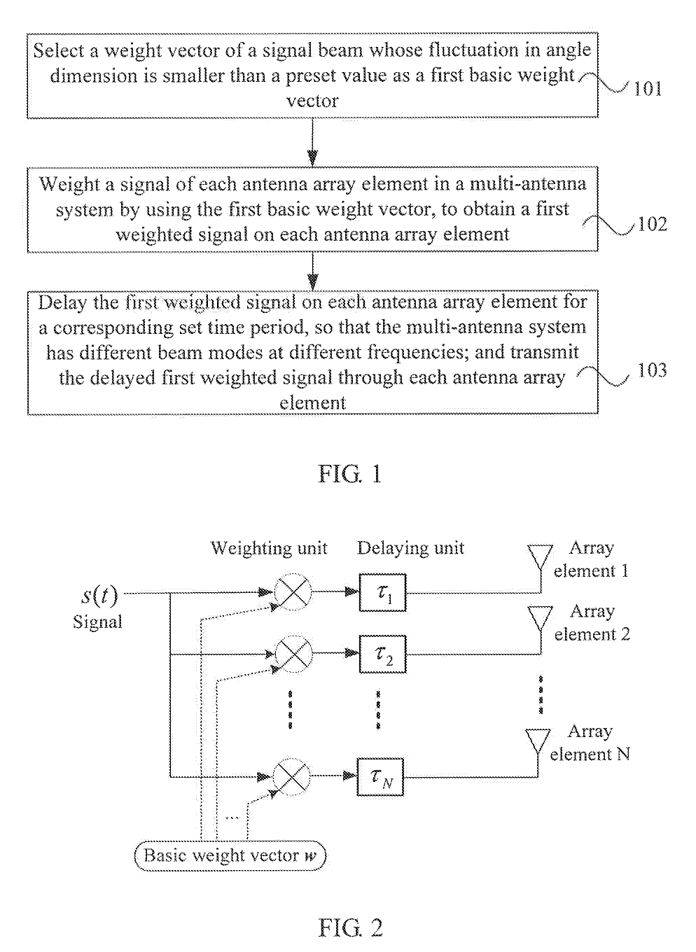

Referring to FIG. 1, a flowchart of a method for controlling multi-antenna signal transmission according to a first embodiment of the present invention is illustrated. As shown in

FIG 1, the method for controlling multi-antenna signal transmission according to this embodiment of the present invention includes the following steps:

Step 101: Select a weight vector of a signal beam whose fluctuation in angle dimension is smaller than a preset value as a first basic weight vector.

FIG. 2 is a schematic structural diagram of a multi-antenna system according to an embodiment of the present invention. As shown in FIG. 2, the multi-antenna system is composed of N antenna array elements, where N is an integer greater than 1. A direction vector corresponding to the multi-antenna system is denoted by α(θ), where α(θ) is an N-dimension column vector, and α(θ)=[α₁(θ) α₂(θ) . . . α_{N}(θ)]^{T}, which is related to a signal transmission direction angle θ. A weighted vector w is selected, and the vector includes N weight coefficients. A transmit signal s(t) is weighted on each antenna array element by using a corresponding weight coefficient and is transmitted. According to the beam-forming theory, it is easy to obtain the beam mode formed by the weight vector on multiple antennas:

g(θ)=w^{H}α (1)

To transmit signals to completely cover all directions of a cell or sector, the weight vector of the signal beam whose fluctuation in angle dimension is smaller than the preset value is selected as the first basic weight vector. The fluctuation of a beam in angle dimension may be measured by a peak-to-average power ratio (Peak to Average Ratio, PAPR) of the beam, a beam amplitude, a power peak value, or the variance of beam amplitudes. The peak-to-average power ratio of the beam may be calculated as follows:

$$PAPR = \frac{{max}_{θ} ( \vert g ( θ ) {\vert}^{2} )}{{\int }_{0}^{2 π} \vert g ( θ ) {\vert}^{2} d θ} \qquad ( 2 )$$

In the above formula, max₇₄(·) denotes the maximum value calculated in angle dimension θ, and |g(θ)| denotes the beam amplitude. The peak amplitude of the beam may be calculated as follows:

Peak=max_{θ}(|g(θ)|)

or Peak=max_{θ}(|g(θ)|²) (3)

The variance of the beam amplitudes may be calculated as follows:

σ²=E[|g(θ)|²]−E²[|g(θ)|] (4)

E[x] denotes the mathematical expectation of a random variant.

It is assumed that the fluctuation is smaller than a preset value α, the beam whose fluctuation is smaller than α may be selected through any of the following manners: selecting a weight vector w corresponding to a beam as a basic weight vector when the peak-to-average power ratio of the beam is smaller than a preset value, that is, PAPR≦α₁, the peak value of the beam is smaller than a preset value, that is, Peak≦α₂, or the amplitude variance of the beam is smaller than a preset value, that is, σ²≦α₃. The weight vector w is shown in formula (5) and wₙ is a complex weight coefficient.

w=[w₁w₂...w_{N}]^{T} (5)

The multiple antennas may be omni-directional multiple antennas, or directional multiple antennas covering a sector. In the case of the omni-directional multiple antennas, 360-degree omni-directional broadcast signal coverage is required. In the ease of the directional multiple antennas, all directions in the sector corresponding to the directional multiple antennas need to be covered, for example, coverage of 120-degree sector. The method according to in the present invention may be applicable to both the omni-directional multiple antennas and the directional multiple antennas.

Step 102: Weight a signal of each antenna array element in a multi-antenna system by using the first basic weight vector, to obtain a first weighted signal on each antenna array element.

In the first basic weight vector, N weight coefficients are mapped to N antenna array elements according to their sequence in the vector. For example, a first weight coefficient corresponds to a first antenna array element, a second weight coefficient corresponds to a second antenna array element, and by such analogy, and an N^{th} weight coefficient corresponds to an N^{th} antenna array element. A transmit signal on each antenna array element is weighted by using the corresponding weight coefficient, to obtain N weighted signals. The weighted signal on each antenna array element is denoted by:

sₙ(t)=wₙs(t),n=1,...,N (6)
where s(t) denotes the transmit signal, and wₙ denotes the weight coefficient of the basic weight vector in formula (5).

Step 103: Delay the first weighted signal on each antenna array element for a corresponding set time period, so that the multi-antenna system has different transmission modes at different frequencies; and transmit each delayed first weighted signal through its corresponding antenna array element.

In one embodiment, the set time periods corresponding to the antenna array elements are not completely the same; in another embodiment, the set time periods corresponding to the antenna array elements are totally different.

In a traditional beam-forming technology, weighted signals are directly transmitted from their corresponding antenna array elements, to form a desired transmit beam. In this embodiment of the present invention, to obtain frequency diversity, the first weighted signal on each antenna array element is delayed for a corresponding preset time period. In this way, the multi-antenna system has different transmission modes at different frequencies, so that the effect of the frequency diversity is achieved by simply delaying the signal for the preset time period. When a direction angle is fixed, a signal beam mode still varies with a signal frequency. Sufficient frequency diversity is achieved through a simple delay, so that the average beam of beams at all frequencies may be unrelated to the direction angle. In this way, the average transmit power of multi-antenna signals is equal in each direction, so as to effectively implement complete coverage of a cell or sector.

In an embodiment, the preset delay for each array element is τₙ, n=1, . . . ,N. The weighted and delayed transmit signal on each array element is:

sₙ(t)=wₙs(t−τₙ),n=1,...,N (7)

The Fourier transform of the transmit signal s(t) is denoted by:

S(ƒ)=∫_{-∞}^{∞}s(t)e^{-ƒ2πƒt}dt (8)

In formula (7), the Fourier transform of the weighted and delayed signal on each array element is:

Sₙ(ƒ)=∫_{-∞}^{∞}wₙs(t−τₙ)e^{-ƒ2πƒt}dt=S(ƒ)wₙe^{-ƒ2πƒτ}^{_{α}} (9)

Therefore, the equivalent weigh vector formed by signal weighting and signal delaying is

\tilde{w}=[w₁e^{-ƒ2πƒτ}^{₁}w₂e^{-ƒ2πƒτ}^{₂}...w_{N}e^{-ƒ2πƒτ}^{_{N}}]^{T} (10)

The corresponding beam mode is related to the signal frequency, which may be denoted by:

g(θ, ƒ)=\tilde{w}^{H}α(θ) (11)

The beam mode g(θ) of the traditional beamforming in formula (1) is a function related to the direction angle θ. Different beam amplitudes and power exist in different directions. Therefore, all directions of a cell or sector cannot be covered. However, according to this embodiment of the present invention, the beam mode g(θ, ƒ) is a binary function of the direction angle and signal frequency. When the direction angle is fixed, the beam mode still varies with the signal frequency. Sufficient frequency diversity may ensure that the average beam of the beams at all frequencies is unrelated to the direction angle, so that the average transmit power of the multi-antenna signals is equal in each direction.

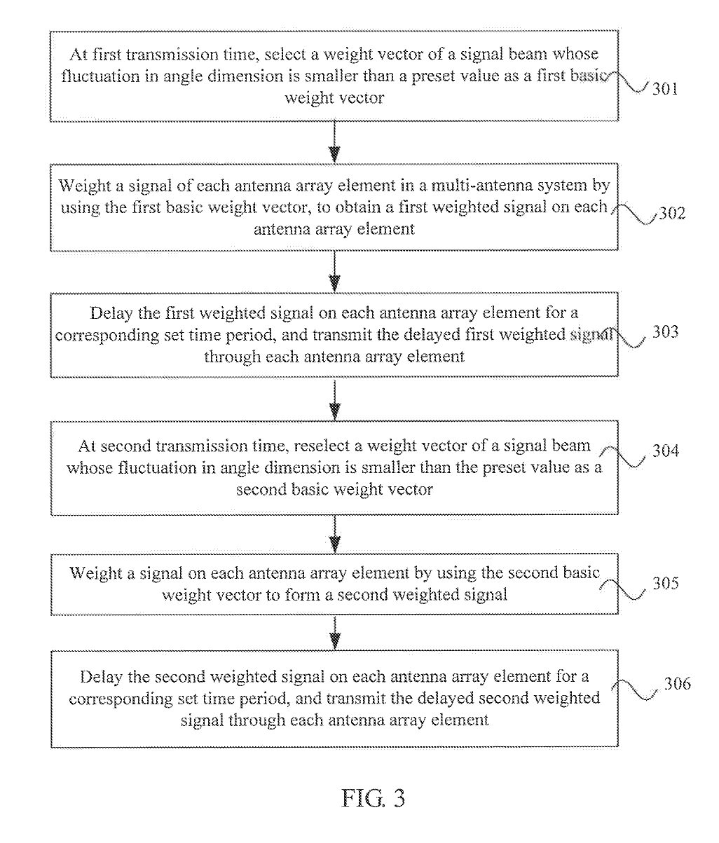

A second embodiment of the method for controlling multi-antenna signal transmission is provided. According to the second embodiment, a time protection interval of mobile communication signals may not be too long. Therefore, the length of delay is restricted, and for a short delay, sufficient frequency diversity cannot be obtained. According to this embodiment of the present invention, different basic weight vectors are selected in different transmit timeslots, and the time dimension g(θ, ƒ, t) r added in a beam mode. FIG. 3 is a flowchart of the method for controlling multi-antenna signal transmission according to the second embodiment of the present invention. As shown in FIG. 3, the specific method is:

Step 301: At first transmission time, select a weight vector of a signal beam whose fluctuation in angle dimension is smaller than a preset value as a first basic weight vector.

The weight vector of the signal beam whose fluctuation in angle dimension is smaller than the preset value may be selected in any of the following manners: selecting a weight vector of a signal beam as a basic weight vector, when the peak-to-average power ratio of the beam is smaller than a preset value, the peak value of a beam amplitude or the peak value of beam power is smaller than a preset value, or the variance of beam amplitudes is smaller than a preset value.

Step 302: Weight a signal of each antenna array element in a multi-antenna system by using the first basic weight vector, to obtain a first weighted signal on each antenna array element.

Step 303: Delay the first weighted signal on each antenna array element for a corresponding set time period, and transmit each delayed first weighted signal through its corresponding antenna array element. Each first weighted signal is delayed for its corresponding set time period, so that the multi-antenna system has different transmission modes at different frequencies.

Step 304: At second transmission time, according to the method in step 301, reselect weight vector of a signal beam whose fluctuation in angle dimension is smaller than a preset value as a second basic weight vector.

Step 305: According to the method in step 302, weight the signal of each antenna array element by using the second basic weight vector, to form a second weighted signal.

Step 306: According to the method in step 303, delay the second weighted signal on each antenna array element for a corresponding set time period, and transmit each signal through its corresponding antenna array element. Each second weighted signal is delayed for its corresponding set time period, so that the multi-antenna system has different transmission modes at different frequencies.

In this embodiment of the present invention, the first basic weight vector may be equal or not equal to the second basic weight vector.

The following uses a case where eight omni-directional antenna array elements are included and the interval between array elements is a uniform-spaced linear array (Uniform-spaced Linear Array, ULA) with half-wavelength antenna spacing as an example to further describe the technical solution of the present invention. The direction vector corresponding to the ULA is:

α(θ)=[1e^{-ƒπsinθ}e^{-ƒ2πsinθ}...e^{-ƒ1πsinθ}]^{T} (12)

According to the above method for selecting the basic weight vector, the following weight basic vector is selected:

w=[111−11−1−11]^{T} (13)

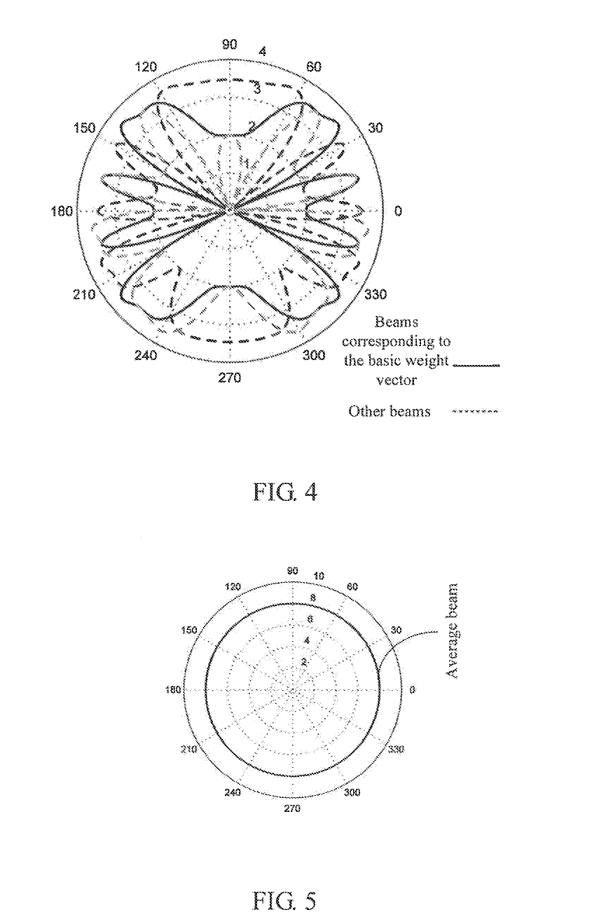

FIG. 4 is a beam direction diagram of the method for controlling multi-antenna signal transmission according to the second embodiment of the present invention.

In an embodiment, a transmission mode of the multi-antenna system may be represented by a beam direction diagram. The solid lines in FIG. 4 illustrate the beam corresponding to the basic weight vector. The fluctuation of the beam in angle dimension is smaller than a preset value, and the beam has the feature of a wide coverage angle and a flat beam amplitude. It is assumed that linear incremental delay is performed for a weighted signal on each array element. The delay increment of two adjacent array elements is Δτ, and the delay of the weighted signal on each array element is:

τₙ=(n−1)Δτ,n=1,2,3,...N (14)
τₙ denotes the length of the delay of a weighted signal on an n^{th} array element.

The following is the beam mode generated after linear incremental delay; that is, the specific beam direction diagram in the ULA in formula (11):

$$g ( f , θ ) = {\tilde{w}}^{H} a ( θ ) = {\sum }_{n = 1}^{8} {w}_{n} {e}^{- j π ( n - 1 ) ( sin θ + 2 fΔ r )} \qquad ( 15 )$$

The beam direction diagram is related to a frequency. Beams at different signal frequencies are different. Therefore, the frequency diversity may be obtained. As shown in FIG. 4, the solid lines illustrate shaped beams of the basic weight vector (not delayed), and other beams (illustrated by the broken lines) illustrate a direction diagram of two beams selected at different frequencies after the delay. It can be seen that, the direction diagrams of beams at different frequencies after the delay are different. That is to say, the multi-antenna system has different transmission modes at the two different frequencies. It can be easily understood that FIG. 4 merely illustrates an example of two different frequencies. In another embodiment, the number of frequencies may be N, N being an integer greater than 0. After the delay according to this embodiment of the present invention is used, different beam direction diagrams are available at the N different frequencies. That is, the multi-antenna system has different transmission modes at the N different frequencies.

FIG. 5 is a direction diagram of the average beam of all beams at different signal frequencies according to an embodiment of the present invention. As shown in FIG. 5, the average beam is illustrated as a round shape. Obviously, transmit power at all directions are equal, so cell coverage can be realized.

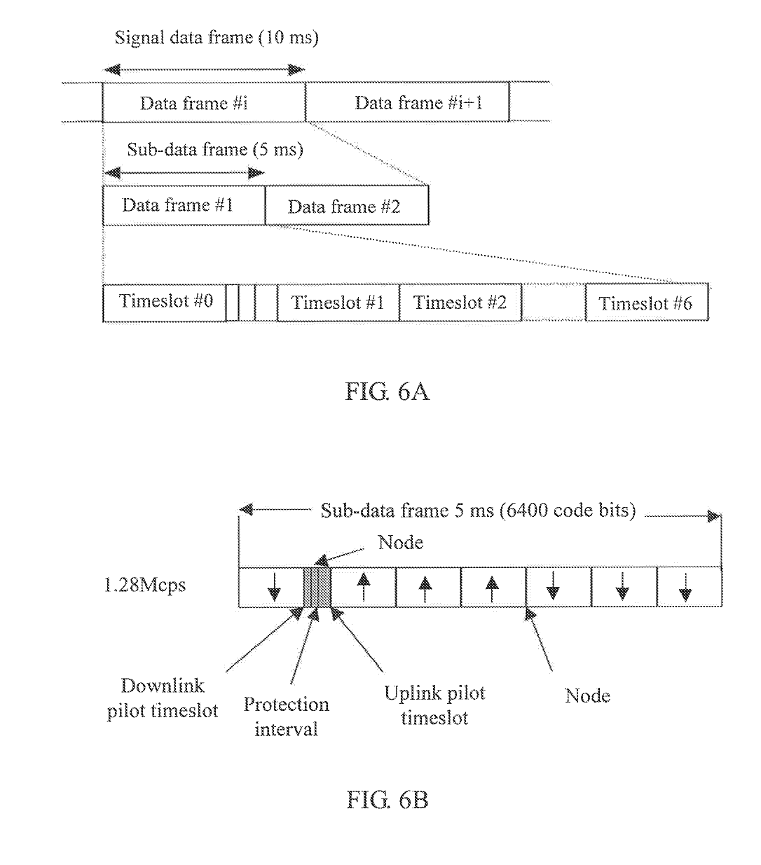

According to a third embodiment of the method for controlling multi-antenna signal transmission, the following uses a TD-SCDMA system as a specific embodiment to further describe the technical solution of the present invention, The TD-SCDMA system uses the intelligent antenna and code division multiple address (CDMA) technologies. Compared with technologies, such as orthogonal frequency division multiplexing (OFDM), the TD-SCDMA system cannot explicitly obtain a random width beam in a frequency domain. FIG. 6A is a schematic structural diagram of a frame in a TD-SCDMA system according to an embodiment of the present invention; FIG. 6B is a schematic structural diagram of a timeslot in a TD-SCDMA system according to an embodiment of the present invention. As shown in FIG. 6A and FIG. 6B, each transmission time interval (Transmission Time Interval, TTI) is 4 ms. If a random beam-forming technology is used, at most eight different random width beams may be obtained in time dimension, and diversity performance may be affected. The specific process for controlling signal transmission according to the embodiment of the present invention includes the following:

According to the method in step 101, select a weight vector of a signal beam whose fluctuation in angle dimension is smaller than a preset value as a basic weight vector.

According to the method in step 102, weight a signal of each antenna array element in a TD-SCDMA system by using the basic weight vector in step 101, to obtain a weighted signal on each antenna array element.

According to the method in step 103, delay the weighted signal on each antenna array element for a corresponding set time period, and transmit each signal through its corresponding antenna array element. Each weighted signal is delayed for its corresponding set time period, so that the multi-antenna system has different transmission modes at different frequencies.

It can been learned from formulas (10) and (11) that an equivalent weight coefficient after the signal delay is equal to an original weight coefficient multiplied by a weight factor e^{-ƒ2πƒτ}^{₁}. In the case of linear incremental delay, a weight factor at a highest signal frequency is e^{-ƒ2πB}^{_{w}}^{Δτ}. When B_{w}Δτ=1, the corresponding beam overlaps the beam of the basic weight vector. That is, the beam patterns generated through the delay at different frequencies are traversable in angle dimension, and the average beam can achieve an isotropic coverage of a cell.

The method for calculating the length of the delay is as follows: It is assumed that the bandwidth of a baseband signal is B_{w}, if the delay with the linear increment Δτ is performed for each array element, the requirement for implementing that average transmit power is equal in each direction within a 360-degree range by completely depending on the frequency diversity is B_{w}Δτ≧1. That is, the requirement for achieving an isotropic coverage is B_{w}Δτ≦1.

In the TD-SCDMA, the bandwidth of a signal is 1.28 MHz. According to the rule B_{w}Δτ≧1, the required delay increment is:

$$Δτ \geq \frac{1}{{B}_{w}} = \frac{1}{1.28 \times {10}^{6}} = 0.78125 us \qquad ( 16 )$$

The rate of a code bit is 1.28 MHz, and the length of the code bit is 0.78125 us. Therefore, when the delay increment on each array element is a code bit, an isotropic coverage of a cell can be achieved.

In addition, in the TD-SCDMA system, the protection interval of a signal timeslot is the length of 16 code bits. In actual system design, the length of delay is not expected to be too long.

For example, typically the maximum delay is expected to be limited within two code bits. In the above linear delay solution with one code bit as the increment, if eight antenna arrays are used, the maximum delay is seven code bits. In this case, within one timeslot, sufficient frequency diversity cannot be implemented by depending on the delay. However, in the case of short delay, omni-directional coverage can be implemented by using different basic weight vectors within different timeslots. The specific process includes:
at first transmission time, selecting a weight vector of a signal beam whose fluctuation in angle dimension is smaller than a preset value as a first basic weight vector;
weighting a signal of each antenna array element in the TD-SCDMA system by using the basic weight vector, to obtain a first weighted signal on each antenna array element;
delaying the first weighted signal on each antenna array element for a corresponding set time period and transmitting each signal through its corresponding antenna array element, where the maximum delay on each array element does not exceed two code bits;
at second transmission time, reselecting a weight vector of a signal beam whose fluctuation in angle dimension is smaller than the preset value as a second basic weight vector;
weighting a signal of each antenna array element in a TD-SCDMA system by using the second basic weight vector, to obtain a second weighted signal on each antenna array element; and
delaying the second weighted signal on each antenna for a corresponding set time period, and transmitting each signal through its corresponding antenna array element, where the maximum delay on each array element does not exceed two code bits.

In a practical application, by such analogy, the above steps are repeated.

To further verify the effect of signal transmission performed by using the method for controlling multi-antenna signal transmission according to the embodiment of the present invention, emulation verification is performed by using Vehicular A channel whose channel model is compliant with the Third Generation Partnership Project (Third Generation Partnership Project, 3GPP). Table 1 shows parameters of the channel and emulation parameters.

TABLE 1

| Sampling | Channel A | |
|---|---|---|
| | Delay (ns) | Power (dB) |
| 1 | 0 | 0 |
| 2 | 310 | −1.0 |
| 3 | 710 | −9.0 |
| 4 | 1090 | −10.0 |
| 5 | 1730 | −15.0 |
| 6 | 2510 | −20.0 |

| Emulation parameter | Parameter value |
|---|---|
| Channel coding | LDPC code defined in WiMAX (IEEE802.16e), code |
| | length 576, code rate ½; convolution code (CC), |
| | code rate ½, restricted length 10, code polynomial |
| | [1167, 1545], Viterbi decoding |
| Interleave length | 40 ms |
| Modulation | QPSK |
| OFDM modulation | DFT length 512, cyclic prefix length 32 |
| Multi-antenna | Uniform-spaced linear array (ULA), eight array |
| | elements, half-wavelength array element spacing |
| Beamforming | Basic weight vector w = [1 1 1 −1 1 −1 −1 1]^{T} |

In the test of the emulation verification according to the embodiment of the present invention, eight omni-directional antenna array elements are used, the interval between array elements which is half-wavelength uniform-spaced linear multiple antennas are used, each array element of the multiple antennas are weighed by the corresponding basic weight vector, and linear incremental delay is performed. That is, a first antenna array element is not delayed, a second antenna array element is delayed by Δτ, a third antenna array element is delayed by 2Δτ, and by analogy. The transmit signals are channel-coded by using a low density parity check code (Low Density Parity Check Code, LDPC) and a convolution code (Convolution Code, CC); and in addition, 40 ms interleaving and quadrature phase shift keying (Quadrature Phase Shift Keying, QPSK) modulation are performed for the transmit signals.

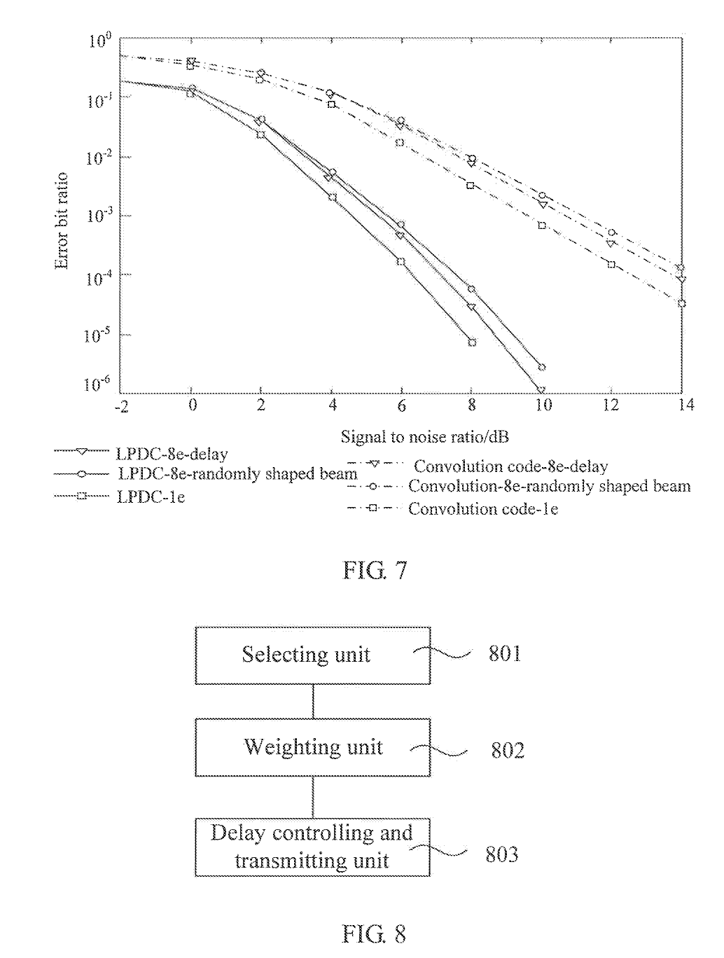

FIG. 7 is a curve diagram of emulation verification of a method for controlling multi-antenna signal transmission according to an embodiment of the present invention. As shown in FIG. 7, the LDPC and CC indicate channel coding manners; 1e indicates single-antenna transmission, and 8e indicates ULA transmission of eight array elements, with total transmit power unchanged; and Random BF indicates a conventional random beamforming technology. It can be seen from FIG. 7 that regardless of strong coding or weak coding, the delay solution provided in the method for controlling multi-antenna signal transmission implements the gain of 0.5 dB when compared with the random beamforming solution in the prior art, and narrows down the distance from its performance to the theoretical performance threshold of omni-directional coverage. That is, the performance of multi-antenna signal transmission according to the embodiment of the present invention is closer to the performance of an omni-directional single antenna.

In the method for controlling multi-antenna signal transmission according to the embodiment of the present invention, the weight vector of the signal beam whose fluctuation is smaller than the preset value is selected as the basic weight vector to perform weight processing, and the signal after the weight processing is delayed and then transmitted, which not only enables the signals to cover all directions of a cell or sector, but also implements implicit frequency diversity. According to the embodiment of the present invention, standards of the conventional communication systems do not need to be largely modified, which facilitates popularity of the technical solutions of the present invention.

An embodiment of the device for controlling multi-antenna signal transmission is provided.

FIG. 8 is a schematic structural diagram of an apparatus for controlling multi-antenna signal transmission according to an embodiment of the present invention. As shown in FIG. 8, the apparatus for controlling multi-antenna signal transmission includes: a selecting unit 801, a weighting unit 802, and a delay controlling and transmitting unit 803. The selecting unit 801 is configured to, at first transmission time, select a weight vector of a signal beam whose fluctuation in angle dimension is smaller than a preset value as a first basic weight vector. The weighting unit 802 is configured to weight a signal of each antenna array element in a multi-antenna system by using the first basic weight vector selected by the selecting unit 801, to obtain a first weighted signal on each antenna array element. The delay controlling and transmitting unit 803 is configured to delay the first weighted signal on each antenna array element for a corresponding set time period, so that each antenna array element has a different transmission beam mode at a different frequency, and transmit each delayed first weighted signal through its corresponding antenna array element.

Further, the selecting unit 801 reselects, at second transmission time, a weight vector of a signal beam whose fluctuation in angle dimension is smaller than the preset value as a second basic weight vector; the weighting unit 802 weights a signal of each antenna array element in the multi-antenna system by using the second basic weight vector, to obtain a second weighted signal on each antenna array element; the delay controlling and transmitting unit 803 delays the second weighted signal on each antenna array element for a corresponding set time period, and transmits each delayed second weighted signal through its corresponding antenna array element For the specific steps performed by the selecting unit 801, reference can be made to step 101, step 301, and step 304; for the specific steps performed by the weighting unit 802, reference can be made to step 102, step 302, and step 305; and for the specific steps performed by the transmitting unit 803, reference can be made to step 103, step 303, and step 306.

According to this embodiment of the present invention, the selecting unit may select the weight vector of the signal beam whose fluctuation in angle dimension is smaller than the preset value as the basic weight vector; the weighting unit weights a signal of each antenna array element in the multiple antennas by using the basic weight vector, to obtain the weighted signal on each antenna array element; and the transmitting unit delays the weighted signal on each antenna array element for the set time period, and transmits the signal, so as to obtain different beam modes related to frequencies. When frequency diversity is sufficient, an average beam is independent from the angle. In this way, the transmit signals with isotropic power may be obtained, so as to effectively implement complete coverage of a cell or sector.

The specific embodiment of a system for controlling multi-antenna signal transmission according to the present invention is provided.

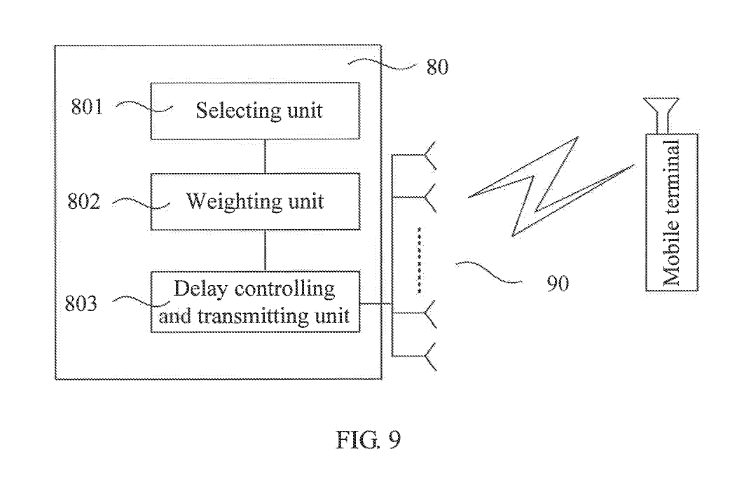

FIG. 9 is a schematic structural diagram of a system for controlling multi-antenna signal transmission according to an embodiment of the present invention. As shown in FIG. 9, the system for controlling multi-antenna signal transmission according to this embodiment of the present invention includes an apparatus 80 for controlling multi-antenna signal transmission and multiple antenna array elements 90. The apparatus 80 for controlling multi-antenna signal transmission includes: a selecting unit 801, a weighting unit 802, and a delay controlling and transmitting unit 803. The selecting unit 801 selects, at first transmission time, a weight vector of a signal beam whose fluctuation in angle dimension is smaller than a preset value as a first basic weight vector. The weighting unit 802 weights a signal of each of the multiple antenna array elements 90 by using the first basic weight vector selected by the selecting unit 801, to obtain a first weighted signal on each antenna array element. The delay controlling and transmitting unit 803 delays the first weighted signal on each antenna array element for a corresponding set time period, so that each antenna array element has a different transmission beam mode at a different frequency, and transmits each delayed first weighted signal through its corresponding antenna array element to a mobile terminal outside the system. Further, the selecting unit 801 reselects, at second transmission time, a weight vector of a signal beam whose fluctuation in angle dimension is smaller than the preset value as a second basic weight vector. The weighting unit 802 weights a signal of each of the multiple antenna array elements 90 by using the second basic weight vector, to obtain a second weighted signal on each antenna array element. The delay controlling and transmitting unit 803 delays the second weighted signal on each antenna array element for a corresponding set time period, and transmits each delayed signal through its corresponding antenna array element to the mobile terminal outside the system. For the specific steps performed by the selecting unit 801, reference can be made to step 101, step 301, and step 304; for the specific steps performed by the weighting unit 802, reference can be made to step 102, step 302, and step 305; and for the specific steps performed by the transmitting unit 803, reference can be made to step 103, step 303, and step 306.

In the system for controlling multi-antenna signal transmission according to this embodiment of the present invention, the selecting unit in the apparatus for controlling multi-antenna signal transmission may select the weight vector of the signal beam whose fluctuation in angle dimension is smaller than the preset value as the basic weight vector; the weighting unit weights a signal of each antenna array element in multiple antennas by using the basic weight vector, to obtain the weighted signal on each antenna array element; and the transmitting unit delays the weighted signal on each antenna array element for the set time period, and transmits the signal, so as to obtain different beam modes related to frequencies. When frequency diversity is sufficient, an average beam is unrelated to a direction angle. In this way, transmit signals having the same transmit power in all directions may be obtained, so as to effectively implement complete coverage of a cell or sector.

Persons of ordinary skills in the art may understand that all or part of steps according to the embodiments of the present invention may be implemented by a program instructing relevant hardware. The program may be stored in a computer readable storage medium. When the program is executed, the steps of the method in the embodiments are executed. The storage medium includes any medium capable of storing program codes, such as a ROM, a RAM, a magnetic disk, or a CD-ROM.

Finally, it should be noted that the above embodiments are merely provided for describing the technical solutions of the present invention, but not intended to limit the present invention. It should be understood by persons of ordinary skill in the art that though the present invention has been described in detail with reference to the embodiments, modifications can be made to the technical solutions described in the embodiments, or equivalent replacements can be made to some technical features in the technical solutions, as long as such modifications or replacements do not cause the essence of corresponding technical solutions to depart from the scope of the embodiments of the present invention.

What is claimed is:

1. A method for controlling multi-antenna signal transmission, comprising:
at a first transmission time, selecting a weight vector of a signal beam whose fluctuation in angle dimension is smaller than a preset value as a first basic. weight vector;
weighting a signal of each antenna array element in a multi-antenna system by using the first basic weight vector, to obtain a first weighted signal on each antenna array element; and
delaying the first weighted signal on each antenna array element for a corresponding set time period, so that the multi-antenna system has different transmission modes at different frequencies; and transmitting each delayed first weighted signal through its corresponding antenna array element.

2. The method for controlling multi-antenna signal transmission according to claim 1, further comprising:
at a second transmission time, reselecting a weight vector of a signal beam whose fluctuation in angle dimension is smaller than the preset value as a second basic weight vector;
weighting a signal of each antenna array element in the multi-antenna system by using the second basic weight vector, to obtain a second weighted signal on each antenna array element; and
delaying the second weighted signal on each antenna array element for the corresponding set time period, so that the multi-antenna system has different transmission modes at different frequencies; and transmitting each delayed second weighted signal through its corresponding antenna array element.

3. The method for controlling multi-antenna signal transmission according to claim 1, wherein the weight vector of the signal beam whose fluctuation in angle dimension is smaller than the preset value comprises:
a weight vector of a signal beam whose peak-to-average power ratio in angle dimension is smaller than a preset value;
or a weight vector of a signal beam whose peak value in angle dimension is smaller than a preset value;
or a weight vector of a signal beam whose beam amplitude variance in angle dimension is smaller than a preset value.

4. The method for controlling multi-antenna signal transmission according to claim 1, wherein the set time periods corresponding to the antenna array elements are different.

5. The method for controlling multi-antenna signal transmission according to claim 1, wherein the delaying the weighted signal on each antenna array element for the corresponding set time period comprises:
delaying a weighted signal on an L^{th} antenna array element by (L−1Δτ, where L is greater than “1”; wherein the weighted signal comprises the first weighted signal and/or the second weighted signal.

6. The method for controlling multi-antenna signal transmission according to claim 5, wherein delaying a weighted signal on an L^{th} antenna array element by (L−1)Δτ, where L is greater than “1” comprises:
in a TD-SCDMA system, setting a maximum delay (L−1)Δτ to a value not exceeding a length of two code bits.

7. An apparatus for controlling multi-antenna signal transmission, comprising:
a selecting unit, configured to, at a first transmission time, select a weight vector of a signal beam whose fluctuation in angle dimension is smaller than a preset value as a first basic weight vector;
a weighting unit, configured to weight a signal of each antenna array element in a multi-antenna system by using the first basic weight vector, to obtain a first weighted signal on each antenna array element; and
a delay controlling and transmitting unit, configured to delay the first weighted signal on each antenna array element for a corresponding set time period, so that each antenna array dement has a different transmission beam mode at a different frequency; and configured to transmit each delayed first weighted signal through its corresponding antenna array element.

8. The apparatus for controlling multi-antenna signal transmission according to claim 7, wherein:
the selecting unit is further configured to, at a second transmission time, reselect a weight vector of a signal beam whose fluctuation in angle dimension is smaller than the preset value as a second basic weight vector;
the weighting unit is further configured to weight a signal of each antenna array element in the multi-antenna system by using the second basic weight vector, to obtain a second weighted signal on each antenna array element; and
the delay controlling and transmitting unit is configured to delay the second weighted signal on each antenna array element for the corresponding set time period, so that the multi-antenna system has different transmission modes at different frequencies; and configured to transmit each delayed second weighted signal through its corresponding antenna array element.

9. A multi-antenna system for controlling multi-antenna signal transmission, comprising: an apparatus for controlling multi-antenna signal transmission and a multi-antenna system comprising multiple antenna array elements; wherein
the apparatus for controlling multi-antenna signal transmission is configured to, at a first transmission time, select a weight vector of a signal beam whose fluctuation in angle dimension is smaller than a preset value as a first basic weight vector; weight a signal of each antenna array element in the multi-antenna system by using the first basic weight vector, to obtain a first weighted signal on each antenna array element; and delay the first weighted signal on each antenna array element for a corresponding set time period, so that the multi-antenna system has different transmission Triodes at different frequencies; and
the multi-antenna system is configured to transmit each delayed first weighted signal through its corresponding antenna array element.

10. The system according to claim 9, wherein the set time periods corresponding to the antenna array elements are different.
